(19) United States
(12) Patent Application Publication
(10) Pub. No.: US 2007/0267237 A1
(43) Pub. Date: Nov. 22, 2007

(54) PLASTIC WHEEL WELLS

(75) Inventors: Donald S. Hanson, Evans, GA (US); Bradley J. Hanson, North Augusta, SC (US); Anthony R. Rossello, Grovetown, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,679

(22) Filed: May 4, 2006

(51) Int. Cl. B62D 31/00

(52) U.S. Cl. 180/89.1

(57) ABSTRACT

A vehicle is provided with a body panel mounted to a frame. The body panel includes a first surface having a first guide member formed thereon. An electrical accessory wire can extend along the first surface of the body panel and be engaged with the first guide member.

### FIELD

The present teachings relate to golf cars and more specifically to wheel wells for golf cars.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many golf cars are equipped with wheel wells coupled to a frame of the golf car. These wheel wells are often coupled to the frame and/or other additional structures using conventional threaded fasteners. Additional wire routing members can be separately coupled to the wheel wells or other golf car structures. This can result in a more complicated design requiring greater assembly times.

### SUMMARY

The present disclosure provides a vehicle including a body panel mounted to a frame. The body panel can include a first surface including a first guide member formed therewith. An electrical accessory wire can extend along the first surface and be engaged with the first guide member. A series of apertures can also be located in the wheel wells and have a push-in fastener passing therethrough, coupling the wheel well to the vehicle frame.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a perspective view of a golf car including the wheel well of the present disclosure;

FIG. 2 is an exploded view showing the wheel well of the present disclosure and the golf car frame; and

FIG. 3 is an additional exploded view of the wheel well and frame shown in FIG. 2.

### DETAILED DESCRIPTION OF THE VARIOUS EMBODIMENTS

The following description of various embodiments is merely exemplary in nature and is in no way intended to limit the present teachings, application, or uses.

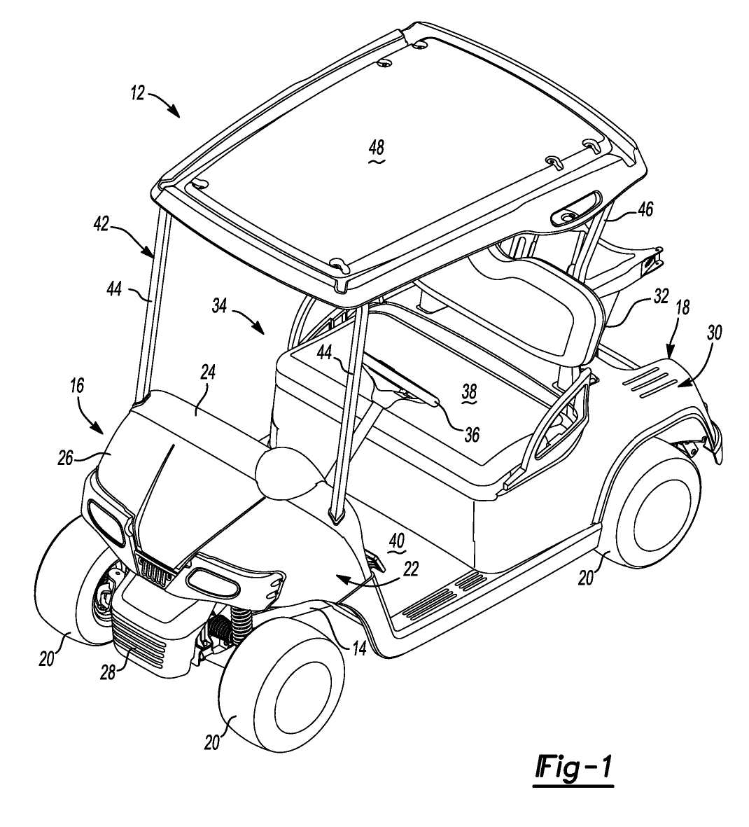

With initial reference to FIGS. 1-3, a wheel well constructed in accordance to the present disclosure is shown and identified generally at reference numeral 10. The wheel well 10 is illustrated operably connected to an exemplary golf car 12. It is appreciated that the golf car 12 is merely exemplary and that the wheel well 10 can be adapted for use with other golf car configurations. Furthermore, the wheel well 10 described herein is not limited for use with golf cars and can also be used with other vehicles such as, but not limited to, utility vehicles, lawnmowers, and other turf care vehicles.

The golf car 12 can include a frame 14 having a front portion 16 and a rear portion 18 mounted thereon. The golf car 12 can further include wheels 20 drivingly coupled to the frame 14.

The front portion 16 of golf car 12 can include a front body assembly 22 having an instrument panel 24, a front cowl 26, and a bumper 28. The rear portion 18 can include a rear body assembly 30 having a golf bag storage area 32 and a passenger seating area 34. The passenger seating area 34 can include a steering wheel 36, accelerator and brake pedals (not shown), a seat 38, and a floor portion 40.

The golf car 12 can further include a strut assembly 42. The strut assembly 42 can include a pair of front struts 44 and a pair of rear struts 46 supporting a roof canopy 48. The pair of front struts 44 can extend between the front portion 16 of the golf car 12 and the roof canopy 48 and the pair of rear struts 46 can extend between the rear portion 18 of the golf car 12 and the roof canopy 48.

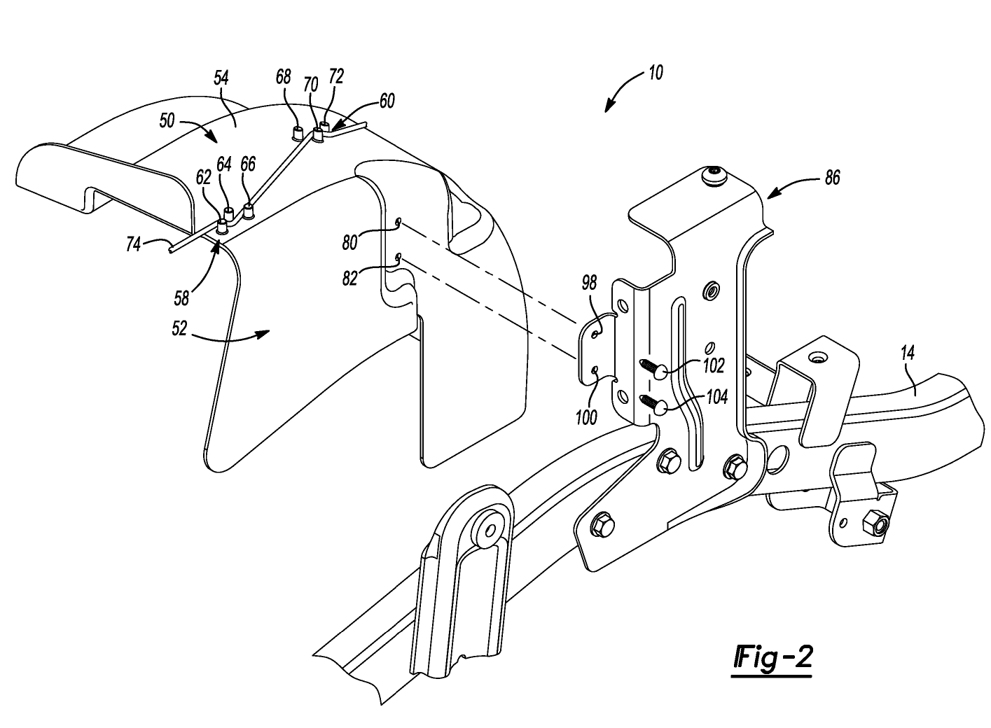

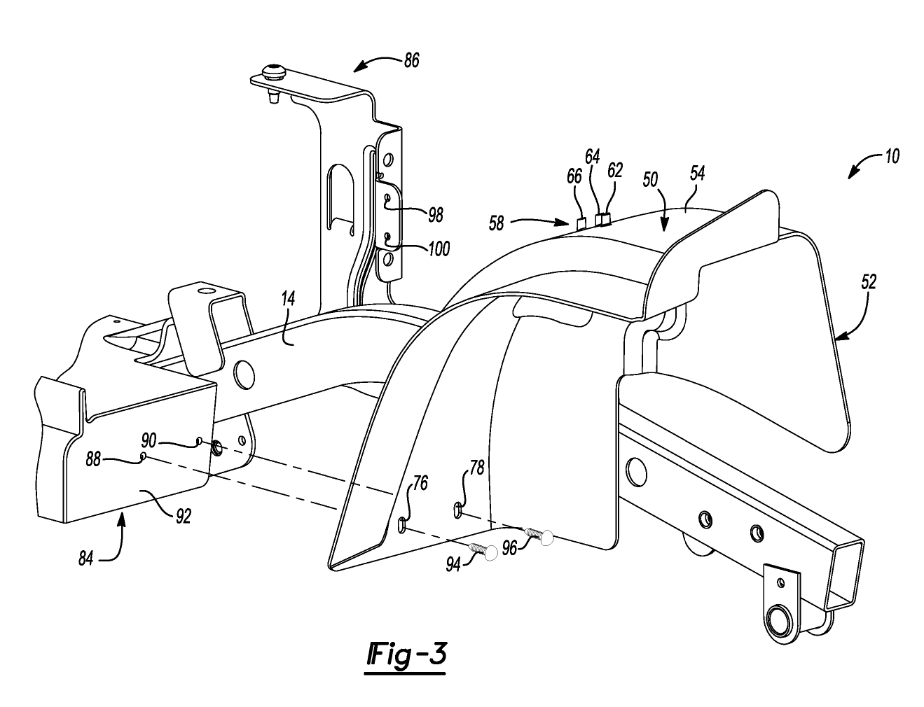

As seen in FIGS. 2 and 3, golf car 12 can include a wheel well 10. A rear driver's side wheel well is shown for simplicity. However, it should be understood that the wheel well 10 can be modified for use in other locations. For example, a mirror image of the rear driver's side wheel well 10 can be used for the rear passenger side wheel well. The wheel well 10 can be located beneath rear body assembly 30 and can be mounted to frame 14. The wheel well 10 can have an upper portion 50 and a side portion 52. The upper portion 50 can have a generally arcuate shape and can generally surround a portion of a wheel 20.

The upper portion 50 can include an upper surface 54. Upper surface 54 can include a first and a second series of integrally formed protrusions 58, 60. The first series of protrusions 58 can be located at an end of upper surface 54 and form a first guide member, while the second series of protrusions 60 can be centrally disposed on upper surface 54 and form a second guide member.

The first series of protrusions 58 can include three protrusions 62, 64, 66. Protrusions 62, 64, 66 can be generally cylindrical in form and extend generally perpendicular from upper surface 54, although other shapes can be utilized and at different angles. Protrusions 62, 66 can be located further inward toward side member 52 than protrusion 64.

The second series of protrusions 60 can also include three protrusions 68, 70, 72. Protrusions 68, 70, 72 can be generally cylindrical in form and extend generally perpendicular from upper surface 54. Protrusions 68, 72 can be located further outward from side member 52 than protrusion 70. While the first and second series of protrusions 58, 60 each can include three protrusions, it is understood that a greater or lesser number can be used as well.

The first and second series of protrusions 58, 60 can have a wire 74 routed between individual protrusions 62, 64, 66, 68, 70, 72. The first and second series of protrusions 58, 60 can generally provide first and second guide members for the wire 74. The distance between adjacent protrusions in each of the first and second series 58, 60 can generally be any distance appropriate to route the wire 74 and to retain the wire in place. For example, the distance could be twice the diameter of the wire 74 or approximately equal to the diameter of the wire 74. Preferably, the distance between the protrusions is greater than the diameter of the wire, but less than twice the diameter of the wire. Wire 74 can be from a variety of sources, such as a rear brake light, or any other item using a wire of some sort.

A second end of upper portion 50 can include apertures 76, 78 therethrough. Apertures 76, 78 can provide a mounting location for coupling wheel well 10 to frame 14, discussed below.

Side portion 52 can also include apertures 80, 82 therethrough. Apertures 80, 82 can provide an additional mounting location for coupling wheel well 10 to frame 14, discussed below.

Wheel well 10 can be formed from a variety of materials, such as plastic or metal. The entire structure of wheel well 10 can be integrally formed, including the first and second series of protrusions 58, 60.

Wheel well 10 can be mounted to frame 14. Frame 14 can include first and second mounting portions 84, 86. First mounting portion 84 can include apertures 88, 90. Apertures 88, 90 can be generally aligned with apertures 76, 78 in wheel well 10. Upper surface 54 of wheel well 10 can generally abut outer surface 92 of first mounting portion 84. Push-in fasteners 94, 96 can be urged into apertures 76, 88 and apertures 78, 90, thereby coupling wheel well 10 to frame 14 at a first location.

Second mounting portion 86 can include apertures 98, 100. Apertures 98, 100 can be generally aligned with apertures 80, 82 in wheel well 10. Side portion 52 of wheel well 10 can generally abut second mounting portion 86. As best shown in FIG. 2, push-in fasteners 102, 104 can be urged into apertures 80, 98 and apertures 82, 100, thereby coupling wheel well 10 to frame 14 at a second location.

The coupling of wheel well 10 to frame 14 can be done entirely with push-in fasteners. Additionally, no assembly is required for the first and second guide members 58, 60. Wire 74 can simply be routed between integrally formed first and second series of protrusions 58, 60. This configuration can result in simplified assembly requiring a fewer number of tools and less time.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A vehicle comprising:
a frame;
a body panel mounted to said frame, said body panel including a first surface, said first surface including a first guide member; and
a wire extending along said first surface, a portion of said wire engaged with said first guide member.

2. The vehicle of claim 1, wherein said first guide member is integrally formed on said first surface.

3. The vehicle of claim 1, wherein said first guide member includes at least two protrusions generally extending from said first surface.

4. The vehicle of claim 3, wherein a distance between said protrusions is greater than the diameter of said wire but less than twice the diameter of said wire.

5. The vehicle of claim 3, wherein a distance between said protrusions is approximately equal to the diameter of said wire.

6. The vehicle of claim 1, wherein said first guide member is disposed toward an end of said first surface and a second guide member is disposed at a central portion of said first surface.

7. The vehicle of claim 1, wherein said body panel includes a first aperture therethrough, said first aperture generally aligned with a second aperture in a mounting surface of said vehicle, said first and second apertures having a push-in fastener passing therethrough, thereby coupling said body panel to said vehicle mounting surface.

8. The vehicle of claim 1, wherein said wire is a brake light wire.

9. The vehicle of claim 1, wherein said body panel is a wheel well, said first surface being an upper surface of said wheel well.

10. The vehicle of claim 9, wherein said wheel well includes an interior side surface, said side surface having at least one aperture therethrough, said aperture aligned with an aperture in said frame, said apertures in said side surface and said frame having a push-in fastener passing therethrough, thereby coupling said wheel well to said frame.

11. The vehicle of claim 1, wherein said vehicle is a golf car.

12. A golf car comprising:
a frame;
a wheel well mounted to said frame, said wheel well having a surface including a first guide member; and
a wire extending along said surface, a portion of said wire engaged with said first guide member.

13. The golf car of claim 12, wherein said first guide member is integrally formed on said surface.

14. The golf car of claim 12, wherein said first guide member includes at least two protrusions generally extending from said upper surface.

15. The golf car of claim 12, wherein said wheel well includes at least one aperture therethrough, and said frame includes at least one aperture, said wheel well aperture and said frame aperture generally aligned with one another and have a push-in fastener passing therethrough, coupling said wheel well to said frame.

16. The golf car of claim 12, wherein said wire is a brake light wire.

17. A wheel well for a vehicle comprising:
a body including an outer member adapted to surround at least a portion of an outer circumference of a wheel, said outer member including a surface having a first guide member, said body further including at least one fastener aperture configured to receive a push-in fastener therethrough.

18. The wheel well of claim 17, wherein said body is comprised of a plastic.

19. The wheel well of claim 17, wherein said first guide member is integrally formed on said surface.

20. The wheel well of claim 17, wherein said first guide member includes at least two protrusions extending from said surface.

21. The wheel well of claim 17, further comprising a second guide member including at least two protrusions integrally formed on and extending from said surface.
